(19) United States
(12) Patent Application Publication
(10) Pub. No.: US 2020/0325077 A1
(43) Pub. Date: Oct. 15, 2020

(54) FOAMING AGENT AND METHOD FOR FOAMING AND STABILIZING FOAMS FOR CONSTRUCTION MATERIALS CONTAINING AIR PORES

(71) Applicant: ML 7 ENTWICKLUNGS GMBH, Wolfsburg (DE)

(72) Inventor: Michael LUEBNITZ, Wolfsburg (DE)

(73) Assignee: ML 7 ENTWICKLUNGS GMBH, Wolfsburg (DE)

(21) Appl. No.: 16/090,759

(22) PCT Filed: Mar. 30, 2017
(86) PCT No.: PCT/EP2017/057587

§ 371 Date: Oct. 2, 2018

(30) Foreign Application Priority Data
Apr. 5, 2016 (DE) 10 2016 106 196.4

(51) Int. Cl. C04B 38/10; C04B 28/14

(52) U.S. Cl. CPC C04B 38/10; C04B 2111/40; C04B 28/14

(57) ABSTRACT

A foaming agent for foaming a binder glue or a binding material slurry for producing air pore containing building materials, particularly filling, lightweight construction and insulating materials, consists of the following:
a) 0.1 to 65.0 wt. % ionic, preferably anionic, foam-forming surfactant;
b) 0.05 to 9.0 wt. %, preferably 1.0 to 7.0 wt. %, particularly preferably 2.0 to 6.0 wt. %, of at least one compound ELF-RG which is solid at room temperature, selected from the group consisting of ethoxylated long-chain fatty alcohols, ethoxylated natural resins, ethoxylated artificial resins and ethoxylated glycols;
c) 0 to 9.0 wt. % fatty alcohol having a chain length of C10 to C18, preferably of C12 to C16;
d) 0.1 to 60.0 wt. % of solvent selected from the group of vicinal diols having from 1 to 6 carbon atoms, diethylene glycol, triethylene glycol and diethylene glycol ethers;
e) 0 to 20 wt. % of organic additives;
f) 0 to 20 wt. % of pH regulators;
g) from 0 to 99.75 wt. % of water,
   wherein the mixture yields a total of 100 wt. %.

The invention relates to the use of novel stabilizers for stabilizing a foam made of a foaming agent for air pore containing building material, a foaming agent for foaming a binder glue or a binding material slurry for producing air pore containing building materials, methods for producing an air pore containing building material as well as air pore containing building materials and construction products obtainable by the methods.

The strength of hydraulically setting building materials is provided by the type, amount and quality of the used binder and is intensified or adjusted as desired by additives and supplements. A binder glue is made from binding agent and water. Components of the binding agent react with the water and bind off. In some cases, this directly yields the building material, e.g. in case of filling gypsum and certain lime plasters. The binder 20 glue in this case forms the binding material slurry directly. In other cases, an aggregate, usually gravel, sand, ashes, fibers or slags, and/or additives in the form of chemical additives of the building material industry such as flow agents, accelerators or retarders are added to the binder glue to impart the desired properties to the binder glue. The water-containing binder glue with aggregates and additives is referred to below as binding material slurry. This viscous slurry sets to become the finished building product.

For the purposes of this description, construction products may be gypsum, concrete, lime or mixtures thereof. The binders include slaked lime, gypsum as natural and FGD gypsum and various types of cement, preferably Portland cement or high-alumina cements. The designation of the binding agents gypsum, lime and cement usually also includes those binding agents which include a minor amount of another binding agent or other additional powdered mineral components, e.g. inorganic oxides (Mg, Si, Fe).

Although the rheology and setting behavior of binding material slurries have been examined in a variety of ways, in particular for concrete and gypsum, they are dependent on a large number of factors due to the numerous possible combinations and have therefore been not investigated conclusively. The number of combinations with aggregates and additives complicates final analysis. In addition, there is often a considerable dependence on processing temperature and pressure. In addition, building materials are natural substances that are subject to natural fluctuations, which is why even with identical mixtures variations in the results may occur.

Lighter and better heat and cold insulating materials have long been known as so-called lightweight or porous building materials, which are of lower density due to air inclusions or addition of light aggregates such as perlites, expanded clay, pumice or cellulose. A disadvantage in comparison to air inclusions is the often high price of the aggregates, their limited availability and their often negative effect on the insulating or sound properties of the building material.

EP 0 568 752 A1 discloses a light gypsum which is produced by adding a mineral, porous filling material and preferably a perlite to a gypsum building material. The pores of the filling material result in a building material, which, compared to solid gypsum, is of lower, adjustable density.

Plasters are used industrially in manifold ways, including as building and modeling materials, as insulating materials, as casting compounds and for medical purposes. Plasters often have desirable processing properties such as good plasticity and moldability before setting and good post-processability and sandability after setting. They provide the desired level of strength for many purposes, are relatively inexpensive and readily available. Chemically, they are sulfates that can be both naturally occurring and synthetically produced in various modifications. The dihydrate (CaSO₄.2H₂O) releases water of crystallization on heating, transitioning first into a hemihydrate and later into an anhydrite. The at least partially dehydrated plaster modifications can take up water and thereby recrystallize. Not fully hydrated gypsum can therefore set under water intake.

Today's building requirements require building materials to be of low weight (low transportation costs, easy processing), good heat and cold insulation values (energy saving), as well as improved soundproofing (living comfort, health). The basis for this are lightweight building materials from which these products can be made. In order to reduce the weight of established building materials and thus to obtain the required properties, air pores can be permanently supplied to the construction slurry in the production process. The binding agents used are thus provided with properties or combinations of properties that products can be produced which are currently not available on the market. Established products can be greatly improved with the help of a stable pore structure or be equipped with new properties. In addition to the use in industrial manufacturing, it is desirable to be able to produce and build in the material on the construction site. The foamed slurry should be stable and processable, be producible in the desired density and be conveyable and processable without any loss of density.

DE 20 56 255 A1 discloses a foaming agent for gypsum and cement compositions using alpha-olefinsulfonates and/or certain alkali, ammonium or ethanolamine salts of sulfuric acid esters of oxyalkylated alcohols as surfactants. Furthermore, additional stabilizers, in particular fatty alcohols, and glycols as cold protection agents can be added. This stabilization is sufficient in some cases for binding material slurries when they are exposed to no or low pressure, are applied only in a low construction height or low temperature fluctuations are expected at the building site. However, the pore structure in the building-material glue can fail at elevated pressure, with a higher construction height or at high temperatures at the building site.

For the production of (pore) lightweight building materials, the binder glue or the binding material slurry are mixed with a foam. The air pores of the foam are retained and the volume of the slurry is increased by the volume of the foam. Since foam only has a low self-weight, the density/weight is thus reduced. The result is a foamed binder glue or a foamed binding material slurry. By drying/curing, this foamed binding material slurry sets to a lightweight building material or pore lightweight building material which contains the air pores of the foam.

### Object of the Invention

Foam formers for gypsum and concrete are not satisfactory for all applications yet since the foamed binding material slurries can spontaneously collapse or the adjusted density cannot be maintained during pumping, pouring or transporting. Unstable air pores burst, the volume decreases and the density increases.

Although stabilizers, which are added to stabilize the foam and thus improve the properties of the foam and hence of the air pore containing building material, often promise more favorable properties, they can seldom keep their promises upon closer examination. Especially under severe conditions (extreme temperatures, temperature fluctuations, temperatures unsuitable for the foaming agent, strong mechanical effects on the material before it reaches the building site or at the building site itself), the stabilizers of the prior art do not render the desired effects.

The object of the invention is to eliminate the disadvantages of the prior art with regard to foam stability and to provide a foaming agent for the production of air pore containing building materials and air pore containing construction products made therefrom, or in general a porous lightweight, filling and insulating material, wherein the foamed binding material slurry not having yet set remains stable under processing conditions and in the drying process. Furthermore, it is an object of the invention to provide a method which facilitates the handling of the foaming agent and thus the production of binding material slurry and air pore containing building materials.

In this sense, the foaming agent is also to be understood as a pore-forming agent for the set building material.

Furthermore, the foamed slurry should remain substantially stable with respect to volume under mechanical stress, i.e. when pumping, lowering or at heights above 10 cm, without developing inhomogeneities. When conveyed by means of suitable pumps (especially: hose and worm pumps), the building material foam should arrive at the building site without significant density loss, remain stable until setting is complete and not develop any instabilities or inhomogeneities.

In addition, the foamed slurry should not change its construction height in the drying, setting or hydration process. If the material is applied at a height of 40 cm, this height should still be present after setting.

The method for the production of lightweight plasters and gypsum foams should be applicable to all pure gypsums, building gypsums, FGD gypsums (alpha and beta hemihydrates) and gypsum mixtures. In addition, other powdery mineral building materials, including lime, limestone, cement, alumina cement and/or siliceous building materials, also in mixture with gypsum and optionally further aggregates, are processable, i.e. foamable with the method.

The method for the production of lightweight concrete shall be applicable to Portland cement of all available variants and grades, including variants already provided with additives and/or aggregates ex factory. As aggregates for pure Portland cement, it is possible to use all known additives and powdery aggregates, in particular mineral building materials, including gypsum, gravel, lime, limestone, high-alumina cement, silicates and/or siliceous building materials.

### SUMMARY OF THE INVENTION

With the use mentioned in the introductory passage, the object is achieved by using at least one ethoxylated compound ELF-RG which is solid at room temperature, selected from the group consisting of ethoxylated long-chain fatty alcohols, ethoxylated natural resins, ethoxylated artificial resins and ethoxylated glycols as stabilizer for stabilizing a foam made of a foaming agent for building materials on the basis of Ionic foaming surfactants for the production of air pore containing construction materials, in particular filling, lightweight and insulating materials.

The object is further achieved by a foaming agent as mentioned in the introductory passage which consists of the following:
a) 0.1 to 65.0 wt. %, preferably 4.0 to 25.0 wt. %, particularly preferably 12.0 to 17.0 wt %, ionic, preferably anionic, foam-forming surfactant;
b) 0.05 to 9.0 wt. %, preferably 1.0 to 7.0 wt. %, particularly preferably 2.0 to 6.0 wt. %, of at least one compound ELF-RG which is solid at room temperature, selected from the group consisting of ethoxylated long-chain fatty alcohols, ethoxylated natural resins, ethoxylated artificial resins and ethoxylated glycols;
c) 0 to 9.0 wt. %, preferably 0.1 to 7.0 wt. %, particularly preferably 2.0 to 6.0 wt. % fatty alcohol having a chain length of C10 to C18, preferably of C12 to C16;
d) 0.1 to 60.0 wt. %, preferably from 10.0 to 55.0 wt. %, particularly preferably from 15 to 50.0 wt. % of solvent selected from the group of vicinal diols having from 1 to 6 carbon atoms, diethylene glycol, triethylene glycol and diethylene glycol ethers;
e) 0 to 20 wt. % of organic additives;
f) 0 to 20 wt. % of pH regulators;
g) 0 to 99.75 wt. %, preferably from 20.0 to 85.0 wt. %, particularly preferably from 5.0 to 75.0 wt. %, of water,
   wherein the mixture yields a total of 100 wt. %.

For the purposes of the present invention, “consists of . . . ” or “consisting of . . . ” is to be understood exhaustively, i.e. no other substances which contribute to the effect of the agent are comprised in addition to the mentioned compounds.

The invention provides a novel foaming agent that is highly stabilized over the agents known in the prior art. The service life of foamed binder glues or binding material slurries obtained with the foaming agent or the pore-forming agent obtained are excellent even at low and high temperatures, under pressure and under mechanical stress. The foamed slurries are pumpable as such and their volume is retained so that they can cure to air pore containing filling, lightweight and insulating materials in a conventional treatment on the building site or in the production of moldings. This applies generally to hydraulically curing building materials. The new foaming agent is usable in combination with various binders and binder mixtures, including gypsum, lime, cement.

In the context of the invention, it has been found that, surprisingly, foams made from a foaming agent for producing air pore containing filling, lightweight construction and insulating materials—namely foamed binder glues and foamed binding material slurries—are excellently stabilized by adding at least one ethoxylated compound solid at room temperature, selected from the group consisting of ethoxylated long-chain fatty alcohols, ethoxylated natural resins, ethoxylated artificial resins and ethoxylated glycols. In particular foaming agents based on ionic foaming surfactants are optimally stabilized by the compounds according to the invention.

Ethoxylation is the addition of ethylene oxide (oxirane) to compounds. The degree of ethoxylation is the amount of ethylene oxide which is bonded to a compound. A degree of ethoxylation from low ethoxylated (1-4 moles of ethylene oxide per mole of ethoxylating compound) to highly ethoxylated (120+ moles) is possible. The degree of ethoxylation influences the water solubility of the substance. Stearyl alcohol (C-18 fatty alcohol) e.g. is not water soluble. Ethoxylation makes the stearyl alcohol accessible to an aqueous solution, here the foaming agent, while maintaining its ability to support a pore-forming agent. Optimum water solubility is not always associated with the highest degree of ethoxylation.

“Water-soluble” in the sense of the present invention means that the ethoxylated compound is dissolved in the unfoamed pore-forming agent without residue, but opacification can occur depending on the material and the temperature. A possible opacification has no negative effect on the functioning and the efficiency of the pore-forming agent.

“Long-chain” in the sense of the present invention means that the ethoxylated fatty alcohol in the carbon skeleton of the alcohol backbone has at least 12 carbon atoms. Particularly suitable for the present invention are fatty alcohols having a basic chain length of 12 to 22 carbon atoms, preferably having a backbone length of 14 to 20 carbon atoms and most preferably having a backbone length of 14 to 18 carbon atoms.

Compounds ELF-RG are known as bases for detergents or cosmetics and can be modified in many ways with respect to the nature of the polymer or fatty alcohol to be ethoxylated and its degree of ethoxylation in order to optimize the effect in relation to the application. Such compounds ELF-RG consist of a lipophilic part, and a hydrophilic part, here ethylene oxide. Due to the hydrophilic part, substances that were previously not water-soluble become water-soluble without losing certain basic properties of the starting material. For example, a hydrophobic long-chain fatty alcohol thus becomes hydrophilic and can be added to the foaming agent as a stabilizer and can unfold its supporting effect without losing its lipophilic character.

It is important that the ethoxylated compound is solid at room temperature. Compounds that are liquid at room temperature do not show the desired stabilization.

In the case of the long-chain fatty alcohols, the degree of ethoxylation of the at least one compound ELF-RG is preferably from 3 to 150, preferably from 25 to 90, particularly preferably 50. For low temperature applications below 30° C., degrees of ethoxylation from 50 to 80, and most preferably 60, are preferred, in the case of high temperatures, a degree of ethoxylation between 10 and 30, preferably 15 and 25, is particularly suitable. To cover a wide temperature range, degrees of ethoxylation of 25 to 60 are particularly suitable.

In the case of natural or artificial resins, the degree of ethoxylation is preferably 3 to 120, preferably 10 to 80, particularly preferably 30 to 60. In the case of the polyethylene glycols, the degree of ethoxylation is preferably in the range from 3 to 120, preferably from 5 to 60, particularly preferably from 15 to 50.

The foaming agents stabilized by the use according to the invention are foaming agents which have long been known as an alternative to porous fillers but which could only be used in isolated cases, namely foaming agents based on ionic foaming surfactants in aqueous organic solvents, generally water-alcohol mixtures, in particular water-glycol mixtures. It is essential that as surfactants highly foam-forming surfactants are used. The foam thus produced is often additionally strengthened with supporting agents, for example fatty alcohols, the fatty alcohol starting from a chain length of 12 C atoms becoming so hydrophobic that the addition into the foaming agent is possible only with the aid of a solvent. Despite solvents, there is a risk that the fatty alcohols used will segregate and lose their effectiveness as supporting agents. Basically, the longer the C chain, the more stable the foam, a use in the pore-forming agent being excluded starting from a chain length of C-14, since the material is hydrophobic and cannot be integrated into the foaming agent. ELF-RG, however, are hydrophilic and have a sufficient chain length of carbon atoms to support the foaming agent beyond what is known to date.

The content of the ELF-RG in the foaming agent not yet combined with a building material component is preferably at least 0.05 wt. % to preferably not more than 9.0 wt. %, but may also be higher depending on the ethoxylated ELF-RG. Foaming agents can be dosed in high amounts, but overdosing reduces the foam stability, and the consumption of the foaming agent required for foam production is Increased. Higher concentrations often cannot achieve further stabilization and are not economically viable.

Commercially available ELF-RG are in solid or waxy form depending on the temperature, the term “solid” as used in the claims encompassing the wax-like form. The wt. % information for the addition to the foaming agent relates to the ELF-RG content for the product as stated by the manufacturer (=substance content or solid content).

The ratio of ELF-RG to surfactant is preferably between 1:12 and 1:1, preferably between 1:12 and 1:6 and particularly preferably 1:3.

Preferably, the ELF-RG for the use of stabilizing the foaming agent foam is applied in combination with at least one fatty alcohol, which will be described in more detail below. The ratio of fatty alcohol to ELF-RG is preferably from 5:1 to 1:4. Most preferably, the ratio is 1:1. As fatty alcohols, those having a chain length of 12 to 16 carbon atoms are particularly suitable. It turned out to be particularly good to use a mixture of C12 and C14 fatty alcohols. The weight ratio of C12 to C14 is preferably between 4:1 and 1:1, very particularly preferably 3:1.

In the present invention, “a ratio of 3:1” means that in 3 parts of the one substance one part of the other substance is contained, that is, 75% of one substance and 25% of the other substance in 100%. The same applies to other ratios.

Furthermore, it is particularly preferred if in addition at least one solvent selected from the group of vicinal diols having 1 to 6 carbon atoms, diethylene glycol, triethylene glycol and diethylene glycol ether is contained in the compound, wherein the ratio of ELF-RG to solvent can be from 1:2 to 1:16 and preferably is 1:9.

The ratio of surfactant to fatty alcohol is preferably from 1:1 to 12:1, more preferably 3:1. The ratio of surfactant to solvent is preferably from 5:1 to 1:12, more preferably 1:3. Finally, the ratio of fatty alcohol to solvent is preferably from 2:1 to 1:16, particularly preferably 1:9.

The generic foaming agent according to the invention in this context consists of the stated basic compounds, the ratios of the individual compounds referring to both, to the usable, diluted foaming agent as well as to concentrates which have to be diluted prior to use.

The content of aqueous-organic solvent, i.e. water-solvent mixture, should be adjusted such that all components dissolve well. The ratios and weight information are indications for the person skilled in the art. Inter alia, the dissolving power depends on the temperature, so that the later processing temperature may be relevant for the 35 choice of the weight ratios; these relationships are known to the person skilled in the art and the foaming agent compositions can be optimized as usual.

The organic admixtures or additives and the pH-adjusting acids and bases (also inorganic) (pH regulators) are present in a proportion of 0 to not more than 20 wt. %. They are not required for some foaming agents. Preferably, therefore, their content is as low as possible, i.e. preferably 0-10 wt. %, more preferably 0-5 wt. %, more preferably 0-3 wt. % and particularly preferably 0-2 wt. %.

In principle, strongly foaming alkali-stable or even alkaline surfactants are suitable as surfactants. A high foaming power is of foremost importance. Anionic surfactants and in particular sulfonates, alkyl sulfonates, in particular alkali metal alkyl sulfonates, alkylene sulfates or alkyl ether sulfonates are preferred. The alkyl chains or alkylene chains of the sulfonates and sulfates are preferably long-chain and more preferably unbranched. Chain lengths greater than or equal to C8 and preferably between C10 and C20 may be considered typical.

Preferred surfactants i.a. include linear alkylate sulfonates, alpha-olefin sulfonates, beta-olefin sulfonates, alkyl ether sulfates, ethoxylated alkylphenols. Currently preferred are alpha-olefin sulfonates, e.g. sodium C14-16-olefin sulfonate, and among the alkyl sulfates SDS and SLS.

Other usable anionic surfactants are acylamino acids and their salts, including acylglutamates, such as sodium acylglutamate, di-TEA-palmitoylaspartate, sodium caprylic/capric glutamate or sodium cocoylglutamate, acylpeptides, including hydrolyzed proteins and protein fractions, sarcosinates, taurates, acyl lactylates, alaninates, alginates, arginates, valinates, prolinates, glycinates, aspartates, propionates, lactylates, amide carboxylates. Furthermore, phosphates/phosphonates can be considered. Further examples are sulfosuccinates, sodium cocomonoglyceride sulfate, sodium lauryl sulfoacetate or magnesium PEG-n-cocoamide sulfate, alkylaryl sulfonates and acyl isethionate, ether and ester carboxylic acids, preferably of fatty acids, and other known foaming anionic surfactants that are commercially available.

It is envisaged that the ionic foam-forming surfactant includes or consists of at least one anionic surfactant. A single surfactant or a mixture of several surfactants may be used. As long as the foaming power is retained, at least one other, in particular nonionic, surfactant may be present in a mixture in addition to at least one anionic surfactant, but this is not preferred.

The solvent from the group of glycols (vicinal 1,2-diols, i.e. alcohols with OH groups on adjacent carbon atoms) is preferably selected from the group consisting of vicinal diols having 1 to 6 carbon atoms, diethylene glycol, triethylene glycol and diethylene glycol ethers, mixtures in each case can be used. Being solvents, the glycols used are naturally liquid at room temperature. Preferred compounds are ethylene glycol, propylene glycol, hexylene glycol, butylene glycol, butyl diglycol, diethylene glycol, dipropylene glycol, diethylene glycol alkyl ethers having C1-C5-alkyl, dipropylene glycol alkyl ethers having C1-C5-alkyl, or mixtures thereof. The solvent co-dissolves all of the foaming agent components and forms a mixed phase with the water present in the foaming agent. Surfactant, ELF-RG and optionally other ingredients are present in an aqueous-glycolic solution. The solvent is present in the foaming agent at 0.1 to 60 wt. %, preferably at ca. 10-55 wt. %, more preferably at ca. 15-50 wt. %.

Preferably, the agent further contains a supporting fatty alcohol, as already known from the prior art according to DE 20 56 255 A1 and DE 38 07 250 A1. The dodecanol mentioned therein can also be used in this invention. In general, long-chain fatty alcohols having a chain length of C12-C22 and preferably C14 to C20 are well suited. Especially suitable are fatty alcohols with a chain length of C1 to C18. By definition, fatty alcohols contain linear or sparingly branched saturated or mono- or polyunsaturated hydrocarbon chains. Commercially available fatty alcohols are often of natural origin and often consist of mixtures for which the average chain length is stated. The chain lengths given above are to be regarded as average lengths in the case of mixtures. With the compound ELF-RG, the fatty alcohol causes the foam generated from the surfactant to be stabilized particularly well, so that the foaming agent also allows for longer lifetime.

The foaming agent, also in concentrate form, always contains a certain amount of water. However, the degree of dilution is flexible. For example, it may be desirable to have the agent as concentrated as possible in order to reduce transport and packaging costs for the transfer to the place of use. On the other hand, it may be advantageous for certain purposes to already have the water required for preparing the binder present in a preparation with the surfactant-containing foaming agent according to this invention, e.g. to save the user measuring and mixing and to allow immediate use at the site. The water content of the agent can also be used to adjust the pH. The most diverse degrees of dilution of the surfactant-containing agent are possible. The water content should be at least 10 wt. % of the foaming agent.

For certain preferred embodiments, the volume of the basic foaming agent or concentrate is further diluted to up to 30 times of its volume with water before it is foamed.

The pH of the foaming agent, which is either used as such in the form of the specified mixture and optionally previously foamed or whose individual compounds are admixed to the overall mixture at a suitable point in the associated preparation process, is preferably greater than or equal to pH 6, particularly preferably the pH is alkaline, i.e. larger than 7. For many applications, the pH can favorably be set to values of 6 to 13, preferably from 7 to 10. For this purpose, if necessary, a base (preferably alkali metal hydroxide solution, NaOH or KOH) may be added to the agent.

The foaming agent may also contain other admixtures, including additives, including pH regulators and supplemental solvents, which, however, should be included only in minor amounts.

Additives may be: retarders, accelerators, dyes, flow agents, water glass, silicic acid, alkali salts and other additives well-known in the concrete, lime and gypsum industries.

Supplementary solvents can be, for example, C1-C20 monools or esters.

For example, butyl acetate or acetyl acetate, methanol or ethanol may be present as an additional solvent in a lesser amount.

However, it is preferred that the foaming agent consists essentially of the claimed and above-mentioned ingredients.

As far as apparent to-date, a particular mixing order is not relevant in the preparation of the foaming agent.

A particular aspect of the invention is that the foaming agent—in particular its concentrate or a slightly diluted embodiment—can be freeze-dried or evaporated in vacuo and so be converted to a dry state. The freeze-dried or otherwise vaporized foaming agent can be stored and transported particularly well. It can also be added directly to the binder and thus yield a self-foaming binder mixture in which the air pores develop in the mixer without the further addition of foaming agents. The dried foaming agent may also be dissolved in water at any time and used further as the liquid foaming agent described in detail above. By drying, a powder is obtained which can be preserved, stored and transported in containers suitable for powder.

The invention further comprises various processes for the production of filling, lightweight construction and insulating materials containing air pores, which can be obtained with the aid of the foaming agent optimally stabilized with ELF-RG according to the invention.

In a first process procedure, a binding material slurry is in principle produced from a binder glue consisting of the compounds binder, mixing water and foaming agent by the optional addition of additives or aggregates into which a foam of foamed pore-forming agent is mixed in and which is further processed to an air pore containing building material. It is not always necessary to add additives to the binder glue. Binder glue in this case is equal to binding material slurry that cures and dries when foaming is completed.

In a second process procedure, in principle, the unfoamed liquid foaming agent is supplied to the mixing water, the binder mixture or in another way to the mixer, in which the materials for the binding material slurry are mixed. Here, the foaming agent may also be added in a powdery, pasty or solid form obtained by freeze-drying. The foaming agent foams in the mixing process, in which the mixing water, solids and additives are combined to the slurry, and thus produces a foamed binding material slurry. The foaming agent is not foamed in advance.

In the first procedure, the foaming agent in a first step is either diluted with water or foamed to a foam with the water already contained in the foaming agent. This happens, for example, in a foam generator. Devices for this purpose are known to the person skilled in the art. The foam thus obtained can then be supplied to the binder glue or to the binding material slurry, in order to yield a (porous) lightweight building material after drying, as described in more detail below.

In preferred embodiments, the foaming agent optionally pre-diluted with water is foamed and the resulting foam is combined either

1. with the mixing water for glue/slurry,
2. with the binder glue from binder and mixing water as well as optional additives or
3. with the binding material slurry from the binder glue and aggregates to yield the foamed building slurry. The foam can either be added indirectly to at least one of the starting materials or directly to the slurry. The foam is added directly to the mixer in which the slurry is produced or the foam is added/injected into the conveying tube of the binding material slurry.

According to a further aspect of the present invention, a method for producing a liquid air pore containing building material, in particular a filling, lightweight construction or insulating material, from a foamed binder glue or from a foamed binding material slurry consisting of binder glue and aggregates and additives, wherein the binder glue consists of mixing water and binder, comprising the following steps is particularly advantageous:
preparing the binder glue by mixing binding agent and mixing water
and where applicable preparing the binding material slurry by mixing the binder glue with aggregates and additives,
   in which method the foaming agent according to the invention, optionally with additional water, is added unfoamed to the dry binding agent, the mixing water, the binder glue or the binding material slurry and the binder glue or the binding material slurry is foamed in the mixer by the mixing process to yield the foamed binder glue or the foamed binding material slurry.

This is possible without restriction for all known binder mixtures, but the efficiency of the foaming agent and the mixing time required vary greatly. In this case, a liquid or a freeze-dried foaming agent is added to the solid mixture, the mixing water or directly in the mixer, in which the material mix is mixed as usual. In this case, the foaming is caused by the intensive mixing of binding agent mixture and mixing water in the selected mixer.

All variants of the method, as explained in greater detail below in connection with the figures using the example of gypsum, are basically suitable for use with different binders, wherein variants of air pore containing filling, lightweight construction and insulating materials, associated products or liquid screeds and similar building materials introduced in liquid form are produced.

As already described above, the binder for the method according to the invention preferably consists of cement, gypsum, lime, in each case alone or in any desired mixture with each other or with other mineral compounds.

The method of the invention includes the ability to transport, preferably to pump, the foamed binding material slurry directly to the building site, and to cure it on site. If the binder in the foamed binding material slurry is Portland cement or high-alumina cement, this material can be used in road construction, where it can replace flint and gravel layers, antifreeze layers, hydraulically bonded (bearing) layers and parts of the asphalt structure.

The foamed binding material slurry can also be introduced into cavities and with other building materials thus result in a composite material system. This is particularly advantageous for floor or facade linings, especially if they are to be carried out later, i.e. in the field of building reconstruction. In particular, the pore lightweight construction and insulation material according to the invention is well suited for insulation and corrective materials in floors, roofs and walls, for screeds and underlying floor corrective compounds, for ceiling and wall plasters.

The foamed binding material slurry obtained according to the various process variants of the invention is stable under processing conditions, i.e. it can be transported in mobile mixers, pressed with suitable pumps through tubes and piping systems, converted into molds for molded products or inserted as an insulating material into interstices or on floors, without increasing or decreasing its density in the process.

However, the method also includes the possibility of casting the building material foam into a mold and thus to produce moldings, in particular building components.

In the production of gypsum plasterboard, the foaming agent can significantly reduce the weight of the end product by increased formation of stable air pores. This can also be done in combination with other aggregates.

In a particularly preferred embodiment, the molding and curing takes place under pressure and elevated temperature in an autoclave, or in a form that provides the conditions of an autoclave. Among other things, this method is very advantageous for the production of mechanically very stable porous lightweight gypsum moldings and products made of autoclaved aerated concrete (YTONG).

Such a method for producing an air pore containing construction product, in particular a filling, building or insulating element, comprises the following steps:
mixing of binding agent, mixing water, possibly aggregates and additives and a foaming agent according to the invention,
filling the resulting mixture into a mold and
obtaining the porous building product by curing the mixture in the mold in an autoclave under at least one of the following conditions: increased pressure, increased relative humidity and elevated temperature.

In a further preferred embodiment, it is possible to produce blocks with one of the above molding methods, from which further products are produced by post-processing. In particular, it is provided that molded or free-cast blocks of lightweight construction and insulating materials obtained by the method according to the invention are cut, sawn or milled into products such as lightweight panels, interior and exterior insulation elements, in particular facade insulations and panels or shaped bricks and shaped elements.

If this method is performed with material of higher density, so that the stability requirements are fulfilled, masonry stones or fire protection boards of different classes can be produced with the method.

### Binding Agent

Methods and foaming agents are applicable to all types of gypsum, i.e. dihydrate, hemihydrate and anhydrite in their various modifications, of natural or synthetic origin, including all FGD gypsums, in particular alpha and beta hemihydrates.

Methods and foaming agents are further applicable to all types and varieties of cements, i.e. Portland cement and high-alumina cement in their various modifications of natural or synthetic origin.

All binders may contain the additives customary for the purposes of use, for example (ground) gravel, sand, silicic acid products, setting retarders and accelerators or the like. However, it is envisaged that the binder fraction based on the dry matter is preferably at least 12.5 wt. %. There are applications in which the binder content in the dry mass is 100 wt. %, so the method is also very well applicable with pure gypsum or pure cement.

Agent and methods according to the invention lead to stable binder foams even with low bulk density (<500 kg/m). Foamed construction products made therefrom have high thermal insulation values.

The density of the foamed binding material slurry and thus the end products can be adjusted within wide limits. As a result, the foamed building material according to the invention can be produced in virtually any desired density. Air pore containing building materials with weights of between about 90 kg/m and 1,700 kg/m have been produced and tested.

The foamed binding material slurries obtained with the agent according to the invention can be processed at temperatures above 0° Celsius and have excellent thermal insulation properties and, despite their low density, very good sound insulation properties.

### DETAILED DESCRIPTION OF THE INVENTION

In the following, the invention will be illustrated by means of formulation and method examples. These serve to better illustrate the invention and do not limit it in its general aspects.

### Formulation Examples—Foaming Agent

### Example Foaming Agent 1

6.0 wt. % anionic surfactant, alkanesulfonate
1.5 wt. % fatty Alcohol, C12-C14 Mix 70:30
18.0 wt. % butyl diglycol (diethylene glycol monobutyl ether)
5.0 wt. % ethoxylated fatty alcohol C16-C18 (degree of ethoxylation: EO 25) 69.5 wt. % water
100% Total solution, application dilution 1:6

### Example Foaming Agent 1 a (Concentrate)

16.0 wt. % anionic surfactant, alkanesulfonate
5.0 wt. % fatty alcohol, C12-C14 Mix 70:30
46.0 wt. % butyl diglycol (diethylene glycol monobutyl ether)
5.0 wt. % ethoxylated fatty alcohol C16-C18 (degree of ethoxylation: 50)
28.0 wt. % water
100% total solution, application dilution 1:12

### Example Foaming Agent 2

10.0 wt. % anionic surfactant, sodium C14-16-olefinsulfonate
10.0 wt. % sulfuric acid ester salt
3.0 wt. % fatty alcohol, C10-C12 Mix 50:50
15.0 wt. % hexylene glycol
3.0 wt. % ethoxylated PEG (polyethylene glycol) (degree of ethoxylation: EO 23)
59.0 wt. % water
100% Total solution, application dilution 1:4

### Example Foaming Agent 3

6.5 wt, % anionic surfactant, sodium C14-16-olefinsulfonate
1.5 wt. % fatty alcohol, C12-C14 Mix 30:70
15.0 wt. % butyldiglycol
5.0 wt. % ethoxylated natural resin (LUCRAMUL U-flakes) (degree of ethoxylation: EO 50)
72.0 wt. % water
100% Total solution, application dilution 1:4

Foams made of these foaming agents are mixed with binder glue or binding material slurry into foamed binding material slurry.

If the ethoxylated compound ELF-RG is omitted in the formulation of a foaming agent, the pore-forming agent loses its stability.

A building material glue is produced as commonly known. For example, the compositions mentioned in example mixture 1, 2 or 2a can be selected. The exact solids composition and the water content depend on the intended use of the foamed slurry. Accordingly, the type and amount of the selected aggregates and composition of the binder mixture are selected. Depending on the desired density of the final product, different amounts of foam are used.

### Example Mixture 1 Gypsum Paste

1. the desired amount of alpha hemihydrate
2.45 wt. % of which is mixing water
3. 2.1% retarder (tartaric acid)

### Example Mixture 2 Cement Paste with Superplasticizer

1. the desired amount of Portland cement
2. 40 wt. % of which is mixing water
3. 2.0 wt. % of the weight of the binder superplasticizer naphthalene sulfonate or MELFLUX (BASF)

### Example Mixture 2 a Cement Paste without Plasticizer

1. the desired amount of Portland cement
2. 60 wt. % of which is mixing water

### Examples Applications

APPLICATION 1: Production of a plasterboard for internal insulation.

Desired wet bulk density=450 kg/m, binder used: gypsum, alpha hemihydrate incl, retarder, aggregates: none.

To prepare a cubic meter of foamed gypsum slurry which achieves the desired density after curing in ambient air in a drying tank, 450 kg of gypsum paste are required. According to Example 1, 450 kg of gypsum paste contains 310 kg of gypsum and 140 liters of water. Gypsum has a density of 1.7. 310 kg of gypsum have a volume of 182.4 liters. Together with the water, this yields a volume of 322.4 liters. The volume short of one cubic meter, i.e. 677.6 liters, is filled up with foam from “example foaming agent 1” and mixed with the glue to yield one cubic meter of foamed gypsum slurry.

APPLICATION 1a: Production of a lightweight concrete slab for external insulation. Desired wet bulk density=600 kg/m, binder used according to example mixture 2.

To produce one cubic meter of foamed slurry, which, after curing in ambient air, reaches the desired density in the drying tank, 600 kg of cement paste are required. According to example mixture 1, 430 kg thereof are cement and 170 liters thereof are water. Cement has a density of 3.1. 430 kg of cement thus have a volume of 139 liters. Together with the water, this yields a volume of 309 liters. The volume short of one cubic meter, i.e. 691 liters, is filled with foam from “example foaming agent 3” and mixed with the glue to yield one cubic meter of foamed slurry.

APPLICATION 2: Preparation of a corrective compound for liquid installation on a construction site below the screed. Desired density=400 kg/m, desired stability 1.5 N/mm², binder used: gypsum, natural anhydrite, aggregates: 25 wt. % gravel ground with a low granulation, inducer potassium sulfate 2.0 wt. % of the binder.

To prepare a foamed gypsum slurry which cures at the building site in the ambient air, kg of anhydrite with a density of 2.2 and a volume of 94l are required. The aggregates have a density of 2.7 and thus a volume of 37 liters, so that 869 liters of foam are needed for one cubic meter of corrective compound. 2 liters of foaming agent according to “example foaming agent 2” are added to the mixing water, and the entire mixture is mixed in an intensive mixer to yield the foamed slurry.

APPLICATION 3: Production of a base layer in road construction, in which use of all layers and elements below the covering asphalt layer may be dispensed with.

Desired density: 850 kg/m³, desired compressive strength: 3.5 N/mm², binder used: Portland cement, CEM I 42.5 N.

To produce a foamed concrete slurry which cures at the building site, according to example mixture 2a 531 kg cement with a density of 3.1 and a volume of 171 liters are needed. Together with the volume of the mixing water of 510 l this yields a volume of liters, which is mixed with 319 liters of foam which was prepared from “Example foaming agent 1”, and yields the desired material.

APPLICATION 4: Production of a lightweight plaster for the interior of an exterior wall. Desired density=750 kg/ma, binding agent used: gypsum, alpha hemihydrate, bagged cargo (available in building centers) 25 kg, supplements: retarder ex factory, otherwise none.

To produce a light plaster of foamed gypsum slurry, which achieves the desired density after curing in the ambient air, 25 kg of gypsum (bagged cargo) are mixed with 10 liters of water to form a gypsum paste. Gypsum has a density of 1.7, which results in a volume of 15 liters for 25 kg of gypsum. Together with the water, this yields a volume of liters.

Alternative 1: The glue is mixed with 25 liters of foam according to “example foaming agent 1” to form a foamed slurry.

Alternative 2: The foaming agent concentrate in dried or pasty form is added to the solid or the mixing water, and the mixture Is foamed in an intensive mixer. For this purpose, 1.0 g of powder (prepared from “Example foaming agent 1”) is added to 25 kg of gypsum.

### DESCRIPTION OF THE DRAWINGS

In the drawing:

FIG. 1 shows the schematic sequence of the production of a lightweight building material on the construction site or in industrial production;

FIG. 2 shows the schematic sequence of the production of lightweight construction material in a somewhat modified process;

FIG. 3 shows the schematic sequence of the production of lightweight construction material using a dried foaming agent.

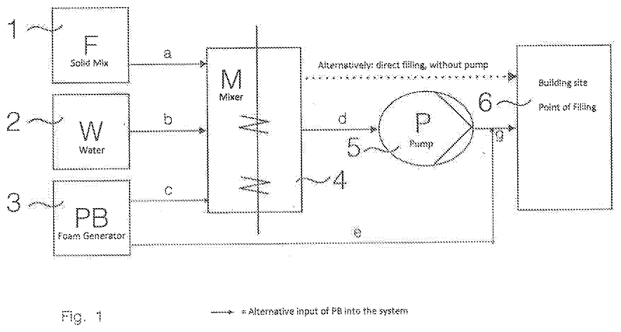

FIG. 1 shows a first process sequence for producing a foamed binding material slurry from which (pore) lightweight construction products result or are produced after drying. The required starting materials are fed from the storage tanks 1, 2 and 3 to a standard mixer 4. A variety of mixer types can be used. However, the mixing intensity should be variably adjustable so that the desired density (the desired pore volume) is achieved when the foaming agent is added to the mixer in unfoamed form.

The binder is placed in the container 1 in dry form. It may include aggregates. This mixture of solids is conveyed into the mixer 4 via a line a. Alternatively, binders and aggregates may be held in separate storage and dispensing containers which would be connected to the mixer via separate lines (not shown). Parallel to this, the mixing water from container 2 is conveyed into the mixer 4 via a line b.

Foam is introduced into foam generator 3 and conveyed into the mixer 4 via a line c. In mixer 4, a foamed binding material slurry is produced, which is conveyed to the building site on a construction site or into a mold for curing by means of a pump 5 via a line d. Alternatively, the foam can be passed directly into the binding material slurry via a line e. For this purpose, the foam from line e is injected into the glue stream of the unfoamed binder glue or the unfoamed binding material slurry.

The transfer lines d, d′ and g may be flexible hoses with which the foamed slurry is conveyed to a building site. Uses of the slurry as insulation material in intermediate walls, as a plaster, as floor corrective compound or screed are possible.

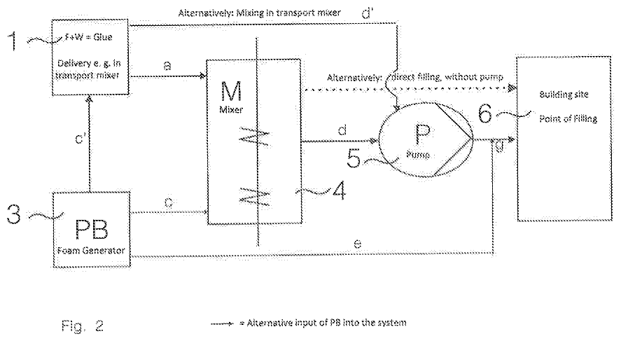

FIG. 2 shows a modified method. Here, a previously, e.g. in a ready-mix concrete plant, generated binder or a binding material slurry is added in container 1 directly from the transport mixer, or the slurry is fed to the pump 5 via line d′. Alternatively, the foam can be added to the transport mixer via line c′, the transport mixer fulfilling the function of mixer 4 and replacing it. The two components binder glue and foam are mixed in mixer 4 or in the transport mixer, and a foamed binding material slurry is formed as in the method of FIG. 1. From the mixer 4 (via path d) or from the transport mixer (via path d′), the foamed binding material slurry is transported by means of pump 5 to the building site 6 or into a mold. Aggregates may have been previously added from a separate container directly into the mixer 4 or the transport mixer.

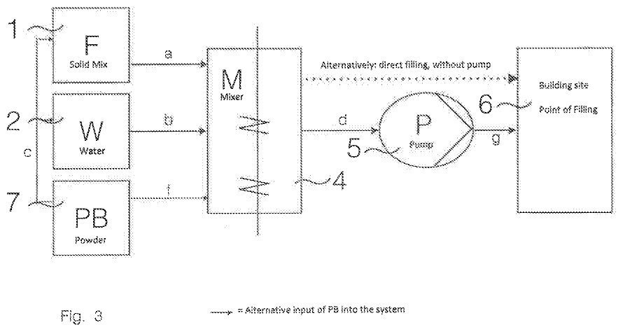

FIG. 3 shows an example of a process procedure in which a powdery, dry foaming agent is used. Again, a mix of solids, i.e. binder and if necessary aggregates, is provided in container 1. Container 2 contains mixing water. Container 7 now contains the dry, for example freeze-dried, foaming agent which is added to the binder in container 1 via line c and/or to the mixing water in container 2. The powdery foaming agent is fed to mixer 4 via the flow of material, or it is directly added to the mixer 4 (in this case schematically path a, b, f). In the mixer 4, a binder glue foam or a foamed binding material slurry is produced, which is transported to building site 6 by means of pump 5 via the line d or into a mold as already described with respect to the preceding figures.

### Quality Tests

Foamed binding material slurries have to meet pre-defined requirements. These requirements are derived from the desired construction product. The selected composition of the binding material slurry is often a trade secret, and the number of possible combinations and the different concentrations of individual components does not permit a generally valid quality test for foamed binding material slurry. However, a number of general tests have been established which demonstrate the quality of the improved stability of the foaming agent of the binding material slurries claimed by this invention. Of course, a stable foam is not a guarantee for a good construction product by itself. The chosen binder mixture, the additives added and the applied manufacturing and drying process play too large a role for achieving a defined quality. However, no air pore containing building product is possible without a functioning foaming agent. Especially for on-site applications, where critical parameters are constantly changing, robust and reliable foam stability of the used foam is required. In an industrial manufacturing process, the parameter deviations are lower. Material, temperatures, processes are internally standardized. But even here, the pore-forming agent has to withstand the process and offer a robustness that still achieves a satisfactory result in case of parameter deviations.

The tests described below are general in nature and applicable in most cases. Often, only a combination of the described tests can help prove the suitability or non-suitability of a pore-forming agent.

The desired binding material slurry is produced for a quality test series. In the following example we tested the following mixtures:

A—A gypsum paste of alpha hemihydrate, here SOdanit of CASEA GmbH and tap water.

B—A cement paste of Portland cement, here CEM I 42,5 R of Holcim Deutschland and tap water.

Both mixtures are mixed with a foam that is foamed of a foaming agent according to example mixture 3 in a 2-pump foam generator of the company Finke from Detmold.

Basically, the addition of the foam at any time before setting of the building material glue is possible, but should be carried out as soon as possible following glue production. The glue must remain in uncured state to allow mixing with the foam.

In principle, the foamed binding material slurry can be produced in different compositions and different densities.

### Test 1: Pump Stability

The glue or the slurry can be conveyed with all pump types currently available on the market; for foamed slurries, hose and screw pumps are suitable. The variety of available pumping principles and the variable foam adding points require a practical test of whether the desired result can be achieved with the selected pump.

It is irrelevant whether the pumps convey materials produced in batch process or whether the material is continuously produced.

It is irrelevant whether the lightweight gypsum is prepared in advance, in the pump or directly behind the pump in the delivery hose/pipe or in the low-maintenance or maintenance-free swirl/mixer element. However, it should be noted that piston pumps can destroy the pores of foamed slurry.

### Test Procedure:

The density of the foamed slurry is measured before and after pumping. The pumping test is passed if the density measured after pumping corresponds to the density measured before the pumping process or to the predefined target density.

Test 2: Stability while Moving and Pouring

Foamed slurries based on any mixtures of solids must pass from the mixing point to the drying point. The pumping process is described in Test 1. In addition, the material may have to be poured off, i.e. moved again at the building site. This movement is simulated in the test.

### Test Procedure:

The foamed slurry is filled into a container and poured therefrom from a pre-defined height into a second container, possibly the material is stirred at this point or otherwise mechanically moved to simulate the actual production process. Before and after pouring, the density is measured. If a foaming agent according to the invention is used, the density remains unchanged. When pouring foamed binding material slurries according to the invention, drop heights of more than 3 m are possible.

### Test 3: Standing Stability

Depending on the selected composition, the foamed binding material slurry can withstand installation heights of more than 150 cm applied in a single operation. The material remains stable with respect to volume with homogeneously distributed air pores.

### Test Procedure:

Foamed slurry is filled into a container in which the material can dry. After the filling process, the upper filling limit is marked. After drying, the upper edge of the building material must still be at the marked location. If material has sagged during drying, it has lost volume. Pores have dissolved, the contained air has escaped, the material collapses, the density cannot be maintained. The foam is unstable.

### Remarks on the Stabilities Determined in Test 1-3:

Any gypsum-based or cement-based slurry can be foamed if the mixture is not mixed with any additives that neutralize the pore-forming agent or otherwise deprive it of its character (defoamer). In principle, however, volume stability can only be achieved if there is a sufficient amount of suitable binder in the binding material slurry. The best pore-forming agent cannot durably stabilize a mixture that cannot develop sufficient stability from the binder mixture used in the drying process.

An empirical value is that the binder content in the slurry should be at least 12.5% of the total solids mass.

### Test 4: Homogeneity of Air Pore Distribution

In dried building material it may be necessary to determine whether the air pores retain their size and distribution in space in the drying process or whether inhomogeneities have formed. For this purpose, a predefined number of identically dimensioned specimens is cut out of a sufficiently dimensioned body of different layers. With these bodies, the average size of the air pores is determined under a microscope or by means of CRT. Thereafter, the specimens are weighed. Identical densities mean homogeneous distribution of the pores in the system. Inhomogeneities are formed when pores separate from the structure of the foamed binding material slurry and lenses with a higher proportion of pore-forming agent and lenses with a higher proportion of slurry form. The slurry settles mostly on the ground and the pores move upwards. Depending on the application, this development may be an exclusion criterion that makes the foamed binding material slurry unsuitable for the intended use. Test 4 offers a simple means to detect inhomogeneities even without CRT.

### General Remarks Regarding Comparison Tests:

The tests can be carried out individually or in their entirety as suggested and, of course, be further supplemented. If a test procedure is defined and alternative foams are used for the comparison in the test procedure, it is found that foams of foaming agents produced according to the invention are superior to alternative foams in that predefined target values are achieved better in individual or all tests.

### Comparison of Foaming Agents:

For the comparison of a foaming agent according to the invention with an alternative foaming agent, a foaming agent S according to example formulation 3 is compared with a foaming agent S-, where S- also corresponds to example recipe 3, but no ELF-RG is added to the S-. The slurry used in this comparison corresponds to that described in Reference Mix I. The mixture according to Table 1A is brought to the desired density Table 1 B by mixing in prefoamed pore-forming agent. The foamed binding material slurry thus obtained is subjected to Tests 1 to 3. The mixer used was a standard Eirich mixer. The foam was produced with a foam generator of the company Finke. After the preparation, the foam was mixed under the slurry in the standard mixer. The pump used was a hose pump. The filling container is a wooden container made in-house.

Table A shows the test result.

TABLE A

| | Prepara- | Prepara- | Density | Installation | Installation |
|---|---|---|---|---|---|
| | tion | tion | after | height (cm) | height (cm) |
| | density | volume | pump test | Beginning of | End of |
| Name | (kg/m3) | (I) | (kg/m3) | standing test | standing test |
| S | 800 | 500 | 800 | 80 | 80 |
| S− | 800 | 500 | 1,600 | 80 | 47 |

It is found that the foaming agent S passes both the pumping test and the standing test without limitation. Volume and thus density remain the same. When pumping, the density does not decrease. In the standing test, the initial filling level is still present after setting the slurry, i.e. the material has not lost any volume.

Foaming agent S- in comparison shows significant weaknesses. In the pump test, a significant part of the volume is lost. During the standing test, the construction height is reduced by more than 40% from 80 cm to 47 cm. A failure of the pore-forming agent S- is evident. For the standing tests, material with pore-forming agent S- was prepared once more, as the material from the pumping test had already failed. Since it is possible that a material fails during the pumping test but passes the standing test, the standing test was performed with a second mixture.

In this comparison of S and S-, the pore-forming agent is optimally stabilized by the use of ELF-RG according to the invention.

### Reference Mixtures

### I: Lightweight Concrete Production by Supplying a Foam to the Previously Prepared Cement Paste

The following applies to the mixtures according to Table 1 below. All mixtures using the example of cement:

1—Mixture A (reference mixture), unfoamed
2—Mixture B, lightweight concrete, density 0.8 kg/liter or 800 kg/m³
3—Mixture C, lightweight concrete, density 0.4 kg/liter or 400 kg/m³

TABLE 1

| | | Total | of which | of which | of which |
|---|---|---|---|---|---|
| | Density | volume | foam | cement | water |
| Name | (kg/m3) | (I) | (I) | (I) | (I) |
| A | 1,800 | 1,000 | 0 | 400 | 600 |
| B | 800 | 1,000 | 560 | 180 | 260 |
| C | 400 | 1,000 | 775 | 90 | 135 |

The following quantities are required to produce one cubic meter of foamed lightweight concrete:

Cement, Here CEM 1 42.5, Required, Column “of which Cement”:
A: 1,200 kg of cement
B: 540 kg of cement
C: 270 kg of cement
Water, Here Tap Water, Column “of which Water”:
A: 600 kg of water
B: 260 kg of water
C: 135 kg water
Foam, Here Prepared from Reference Mixture 1, Column “of which Foam”:
A—0 liter of foam
B— 560 liters of foam
C— 775 liters of foam

From 60% to 100% of the specified quantities of water can be used without damaging the lightweight concrete structure. Lower or higher water levels are possible but are not recommended due to possible negative effects such as increased toughness, too fast or incomplete setting etc.

The reference mixtures can be prepared with all conceivable solid mixtures and foam densities. In calculation of foam volume and amounts of pore-forming agents derived therefrom, the different density of the solid mix is to be observed.

### II. Light Gypsum Production by Supplying the Unfoamed Foaming Agent for Mixed Water in Gypsum Paste Production

For the production of 5.0 liters of gypsum glue, an alpha-hemihydrate of CASEA GmbH and tap water is used. The gypsum glue is prepared in a 7 liter mixer. An undiluted pore-forming agent according to example foaming agent 1 is added to the mixing water. The pores are created in the glue mixing process.

The following applies to the mixtures according to Table 2 below. All mixtures using the example of plaster:

1—Mixture X (reference mixture), unfoamed
2—Mixture Y, light gypsum, density 0.7 kg/liter or 700 kg/m³
3—Mixture Z, light gypsum, density 0.5 kg/liter or 500 kg/m³

TABLE 2

| | | Total | of which | of which | of which |
|---|---|---|---|---|---|
| | Density | volume | foam | gypsum | water |
| Name | (kg/m3) | (I) | (I) | (I) | (I) |
| X | 1,600 | 5.0 | 0 | 5.5 | 2.75 |
| Y | 700 | 5.0 | 2.9 | 2.3 | 1.15 |
| Z | 500 | 5.0 | 3.5 | 1.8 | 0.63 |

The following quantities are required:

### Gypsum, Here Alpha-Hemihydrate of CASEA GmbH, Column “Thereof Gypsum”:

X: 1,200 kg of gypsum
Y: 540 kg of gypsum
Z: 270 kg of gypsum
Water, Here Tap Water, Column “of which Water”:
X: 2.75 kg of water
Y: 1.1 kg of water
Z: 0.63 kg of water
Foam, Here Produced from Reference Mixture 1, Column “of which Foam”:
X— 0 liter of foam
Y— 2.9 liters of foam
Z— 3.5 liters of foam

### Undiluted Foaming Agent According to Example Foaming Agent 3 is Required as Follows:

a. 0.00 liters
b. 0.02 liters
c. 0.03 liters

1. Use of at least one ethoxylated compound ELF-RG which is solid at room temperature, selected from the group consisting of ethoxylated long-chain fatty alcohols, ethoxylated natural resins, ethoxylated artificial resins and ethoxylated glycols, for stabilizing a foam made of a foaming agent for building materials on the basis of ionic foaming surfactants for the production of air pore containing construction materials, in particular filling, lightweight and insulating materials.

2. Use according to claim 1, characterized in that the content of the ELF-RG in the foaming agent not yet combined with a building material component is at least 0.05 wt. %.

3. Use according to claim 1, characterized in that the at least one compound ELF-RG is employed in combination with at least one fatty alcohol.

4. Foaming agent for foaming a binder glue or a binding material slurry for the production of air pore containing construction materials, in particular filling, lightweight and insulating materials, which agent consists of the following:
a) 0.1 to 65.0 wt. %, preferably 4.0 to 25.0 wt. %, particularly preferably 12.0 to 17.0 wt %, ionic, preferably anionic, foam-forming surfactant;
b) 0.05 to 9.0 wt. %, preferably 1.0 to 7.0 wt. %, particularly preferably 2.0 to 6.0 wt. %, of at least one compound ELF-RG which is solid at room temperature, selected from the group consisting of ethoxylated long-chain fatty alcohols, ethoxylated natural resins, ethoxylated artificial resins and ethoxylated glycols;
c) 0 to 9.0 wt. %, preferably 0.1 to 7.0 wt. %, particularly preferably 2.0 to 6.0 wt. % fatty alcohol having a chain length of C10 to C18, preferably of C12 to C16;
d) 0.1 to 60.0 wt. %, preferably from 10.0 to 55.0 wt. %, particularly preferably from 15 to 50.0 wt. % of solvent selected from the group of vicinal diols having from 1 to 6 carbon atoms, diethylene glycol, triethylene glycol and diethylene glycol ethers;
e) 0 to 20 wt. % of organic additives;
f) 0 to 20 wt. % of pH regulators;
g) 0 to 99.75 wt. %, preferably 20.0 to 85.0 wt. %, particularly preferably 15.0 to 75.0 wt. %, of water,
wherein the mixture yields a total of 100 wt. %.

5. Foaming agent according to claim 4, characterized in that components a) to d) are present in the following ratios:
a) surfactant to b) ELF-RG: 1:1 to 12:1, preferably 3:1;
d) solvent to b) ELF-RG: 2:1 to 16:1, preferably 9:1;
c) fatty alcohol to b) ELF-RG: 1:4 to 5:1, preferably 1:1;
a) surfactant to c) fatty alcohol: 1:1 to 12:1, preferably 3:1;
a) surfactant to d) solvent: 5:1 to 1:12, preferably 1:3;
c) fatty alcohol to d) solvent: 2:1 to 1:16, preferably 1:9.

6. Foaming agent according to claim 4, characterized in that it is diluted to up to 30 times of its volume with water before foaming.

7. Foaming agent according to claim 4, characterized in that it is in pasty or powdery solid state obtainable by freeze-drying or evaporation in vacuo.

8. Method for producing a liquid air pore containing building material, in particular a filling, lightweight construction or insulating material, from a foamed binder glue or from a foamed binding material slurry consisting of binder glue and aggregates and additives, wherein the binder glue consists of mixing water and binder, comprising the following steps:
preparing the binder glue by mixing binding agent and mixing water
and where applicable preparing the binding material slurry by mixing the binder glue with aggregates and additives,
characterized in that the foaming agent according to claim 4, optionally with additional water, is added unfoamed to the dry binding agent, the mixing water, the binder glue or the binding material slurry, and that the binder glue or the binding material slurry is foamed in the mixer by the mixing process to yield the foamed binder glue or the foamed binding material slurry.

9. Method according to claim 8, further comprising the step of curing the binding material slurry to obtain the solid air pore containing building product.

10. Method according to claim 9, further comprising the step of shaping the solid air pore containing building product, particularly by cutting, sawing or milling.

11. Method for producing an air pore containing building material or construction product, in particular a filling, building or insulating element, comprising the following steps:
mixing of binding agent, mixing water, possibly aggregates and additives and a foaming agent according claim 4,
filling the resulting mixture into a mold and
obtaining the porous building product by curing the mixture in the mold in an autoclave under at least one of the following conditions: increased pressure, increased relative humidity and elevated temperature.

12. Method according to claim 11, further comprising the step of shaping the solid air pore containing building product, particularly by cutting, sawing or milling.

13. Liquid air pore containing building material, particularly filling, building or insulating material, obtainable by the method of claim 8.

14. Solid air pore containing building material, particularly filling, building or insulating material, obtainable by the method of claim 9.
